(19) United States
(12) Patent Application Publication
(10) Pub. No.: US 2015/0371241 A1
(43) Pub. Date: Dec. 24, 2015

(54) USER IDENTIFICATION THROUGH SUBSPACE CLUSTERING

(71) Applicant: THOMSON LICENSING, Issy de Moulineaux (FR)

(72) Inventors: Stratis IOANNIDIS, San Francisco, CA (US); Nadia FAWAZ, Santa Clara, CA (US); Andrea MONTANARI, Sunnyvale, CA (US); Amy ZHANG, San Francisco, CA (US)

(73) Assignee: THOMSON LICENSING, Issy de Moulineaux (FR)

(21) Appl. No.: 14/409,772

(22) PCT Filed: Jun. 20, 2013
(86) PCT No.: PCT/IB2013/001543

§ 371 Date: Dec. 19, 2014

Related U.S. Application Data
(60) Provisional application No. 61/662,637, filed on Jun. 21, 2012.

(51) Int. Cl. G06Q 30/02; G06Q 30/06

(52) U.S. Cl. CPC G06Q 30/0201; G06Q 30/0631; G06Q 30/0269

(57) ABSTRACT

A method to detect a number of individual users included in a composite set of movie ratings having ratings from a plurality of individual users includes accessing the composite set of movie ratings and movie profiles and loading the composite set and movie profiles into a rating analysis engine. Processing the composite set along with the movie profiles determines a number of partitions present in the composite set, wherein the number of partitions is determined iteratively using subspace clustering of ratings from the composite set. The determined number of partitions is output and corresponds to the number of individual users included in the composite set of movie ratings.

### CROSS REFERENCE TO RELATED APPLICATION

This application claims priority to U.S. Provisional Application No. 61/662,637 entitled “User Identification Through Subspace Clustering”, filed on 21 Jun. 2012, which is hereby incorporated by reference in its entirety for all purposes.

### FIELD

The present invention relates generally to the data mining More specifically, the invention relates to the determination of the number of users contributing to a set of ratings.

### BACKGROUND

Online commerce services such as Netflix provide personalized recommendations by collecting user ratings about a universe of items, referred to here as ‘movies’. Typically, multiple people within a single household (family members, roommates, etc.) may share the same account for both viewing and rating movies. Service providers are reluctant to deploy multiple accounts as log-in screens are often perceived as a nuisance and a barrier to using the service. This is especially true on devices lacking a keyboard, such as televisions or gaming platforms. Account sharing persists even when providers offer the option of registering secondary accounts, as the latter typically have access to a subset of the services enjoyed by the primary account holder. Finally, sharing might be regarded as a partial (if unconscious) privacy protection mechanism, as users might not want to release the household composition and demographics.

The use of a single account by multiple individuals poses a challenge in providing accurate personalized recommendations. Informally, the recommendations provided to a “composite” account, comprising the ratings of two dissimilar users, may not match the interests of either of these users. Moreover, recommendation methods relying on low-rank assumptions (such as matrix factorization) may fail on data including composite users. This is because “mixing” entries from different rows of a low-rank matrix results in a matrix that need not be low-rank. Beyond personalized recommendations, this ability is useful as it can aid in determining the household's demographics. Such information can be subsequently monetized, e.g., through targeted advertising.

The present invention addresses the challenges of identifying separate users in a composite account, and discovering information related to their profiles.

### SUMMARY

This summary is provided to introduce a selection of concepts in a simplified form that are further described below in the Detailed Description. The Summary is not intended to identify key features or essential features of the claimed subject matter, not is it intended to be used to limit the scope of the claimed subject matter.

The present invention includes a method and apparatus to detect a number of individual users corresponding to movie ratings in a common, composite set of movie ratings. The method includes accessing the composite set of movie ratings and a set of movie profiles by loading both sets into a rating analysis engine. A number of partitions of movie ratings present in the composite set are calculated using the composite set and the movie profiles. The number of partitions is determined iteratively using subspace clustering of ratings from the composite set. The number of determined partitions corresponds to the number of individual users.

Additional features and advantages of the invention will be made apparent from the following detailed description of illustrative embodiments which proceeds with reference to the accompanying figures.

### BRIEF DESCRIPTION OF THE DRAWINGS

The foregoing summary of the invention, as well as the following detailed description of illustrative embodiments, is better understood when read in conjunction with the accompanying drawings, which are included by way of example, and not by way of limitation with regard to the claimed invention.

FIG. 1 illustrates a determination of a hyperplane using movie ratings according to aspects of the invention;

FIG. 2a illustrates a functional diagram of a rating analysis engine according to aspects of the invention;

FIG. 2b illustrates a functional diagram of a partition detector according to aspects of the invention;

FIG. 3 depicts an example embodiment of a rating analysis engine;

FIG. 4a depicts an example web-based rating analysis engine according to aspects of the invention;

FIG. 4b depicts an example set-top-box based rating analysis engine according to aspects of the invention;

FIG. 5 depicts an example flow diagram of the use of a rating analysis engine according to aspects of the invention; and

FIG. 6 depicts an example flow diagram used to detect the number of users in a composite set of ratings.

### DETAILED DISCUSSION OF THE EMBODIMENTS

In the following description of various illustrative embodiments, reference is made to the accompanying drawings, which form a part thereof, and in which is shown, by way of illustration, various embodiments in the invention may be practiced. It is to be understood that other embodiments may be utilized and structural and functional modification may be made without departing from the scope of the present invention.

Initially, a statistical model is developed to help frame an analysis. Consider a dataset of ratings on M movies provided by N accounts, each corresponding to a different household. Ratings are available for a subset of all N×M possible pairs: denoted by [symbol] _{H}⊂[M], where m_{H}≡| [symbol] _{H}|, the set of movies rated by account/household H, and by r_{Hj}∈R the rating of movie j∈ [symbol] _{H}.

Each movie j∈[M] is associated with a feature vector Vⱼ∈ [symbol] ^{d}, where d<<N,M. Matrix factorization is used to extract the latent features for each movie, as further described below. If explicit information (e.g., genres or tags) is available, this can be easily incorporated in the model by extending the vectors vⱼ.

Each household H may comprise one or more users that actually rated the movies in [symbol] _{H}. Denoted by H is the set of users in this household, and by n_{H}=|H| the household size. For each i∈H, denoted by A*ᵢ⊂ [symbol] _{H} is the set of movies rated by i, and by I*(j)∈H the user that rated j∈M_{H}. Note that neither the household size n_{H} nor the mapping I*: [symbol] _{H}→H are a priori known. With this starting point, model selection can used to determine the household size n_{H}. A closely related problem is the one of determining whether the account is composite (i.e., |H|>1) or not. Also, user identification can be performed to identify movies that have been viewed by the same user—i.e., recover partitions I*, up to a permutation, and use this knowledge to profile the individual users.

A linear model is used to help frame an analysis. Focusing now on a single household, and omitting the index H hereafter, denote by n is the household size, Å and m the set of movies rated by this household and its size, respectively, and by rⱼ is the rating given to movie j∈M. One main modeling assumption is that the rating rⱼ generated by a user i∈H for a movie j∈ [symbol] . One is determined by a linear model over the feature vector vⱼ. That is, for each i∈H there exists a vector u*ᵢ∈R^{d} and a real number z*ᵢ∈R (the bias), such that

rⱼ=<u*ᵢ,vⱼ>+z*ᵢ+εⱼ, for all j∈A*ᵢ, i∈H, (1)

where εⱼ∈R are independent, identically distributed (i.i.d.) Gaussian random variables with mean zero and variance σ². Such linear models are used extensively by rating prediction methods that rely on matrix factorization, and are known to perform very well in practice.

Assuming that the household size is known, the model parameters of (1) are (a) the user profiles Θ*={θ*ᵢ}_{i∈H}∈ [symbol] ^{n×d+1}, where θ*ᵢ=(u*ᵢ,z*ᵢ)∈ [symbol] ^{d+1}, i∈H, as well as (b) the mapping I*: [symbol] →H. Given two estimators Θ, I of Θ*, I*, the log-likelihood of the observed sequence of pairs {(vⱼ,rⱼ)}_{j∈} [symbol] , is given by

$$L ( Θ , I ) = - \frac{1}{2 {σ}^{2}} {\sum }_{j ∈} {( {r}_{j} - {z}_{I ( j )} - < {u}_{I ( j )} , {v}_{j} > )}^{2} . \qquad ( 2 )$$

Estimating the maximum likelihood model parameters thus amounts to minimizing the mean square error:

$${min}_{Θ , I} MSE ( Θ , I ) = \frac{1}{m} {\sum }_{j ∈} {( {r}_{j} - {z}_{I ( j )} - < {u}_{I ( j )} , {v}_{j} > )}^{2} , \qquad ( 3 )$$

where Θ∈ [symbol] ^{n×d+1}, I∈J, the set of all mappings from [symbol] to H. Note that (3) is not convex. Nevertheless, fixing I results in a quadratic program, while fixing Θ results in a combinatorial problem solvable in O(nm) time.

Subspace arrangements are now discussed. An insightful geometric interpretation of the minimization (3) is obtained by studying the points xⱼ=(vⱼ,1,rⱼ)∈ [symbol] ^{d+2}, i.e., the d+2-dimensional vectors resulting from appending (1,rⱼ) to the movie profiles. Eq. (1) implies that although the points xⱼ exist in an ambient space of dimension d+2, they actually lie on a lower-dimensional manifold: the union of n hyperplanes, i.e., d+1-dimensional linear subspaces of [symbol] ^{d+2}.

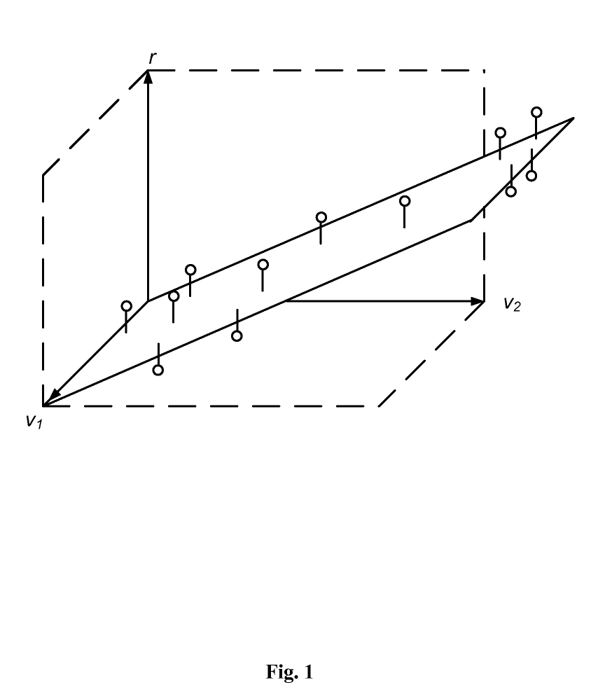

To see this, let n*ᵢ=(uᵢ,zᵢ,−1)∈ [symbol] ^{d+2} be the vector obtained by appending the bias z*ᵢ and −1 to u*ᵢ. Then, |<n*ᵢ,xⱼ>|=|<u*ᵢ,vⱼ>+z*ᵢ−rⱼ|=|εⱼ|, for every j∈Aᵢ. Hence, provided that the variance σ² is small, the points xⱼ lie very close to the hyperplane with normal n*ᵢ that crosses the origin. FIG. 1 depicts an example hyperplane determined using the points of movie ratings. In FIG. 1, for all movies j∈Aᵢ rated by user i∈H, the points xⱼ=(vⱼ,1,rⱼ)∈ [symbol] ^{d+2} lie slightly off a hyperplane whose normal is (uᵢ,zᵢ,−1)∈ [symbol] ^{d+2}.

A union of such affine subspaces is called a subspace arrangement. Given that the data xⱼ, j∈ [symbol] , “almost” lie on such a manifold, minimizing the MSE has the following appealing geometric interpretation. First, mapping a movie j to a user amounts to identifying the hyperplane to which xⱼ is closest to. Second, once movies are thus mapped to users, profiling a user amounts to computing the normal to its corresponding hyperplane. Finally, identifying the number of users in a household amounts to determining the number of hyperplanes in the arrangement.

These tasks are known collectively as the subspace estimation or subspace clustering problem, which has numerous applications in computer vision and image processing. This connection is exploited herein to apply algorithms for subspace clustering on user identification; namely the Expectation Maximization (EM) algorithm and the Generalized Principal Components Analysis (GPCA) algorithm.

Example data sets were applied to the algorithms of the current invention to test its use. One data set is the CAMRa2011 dataset. The CAMRa2011 dataset was released at the Context-Aware Movie Recommendation (CAMRa) challenge at the 5th ACM International Conference on Recommender Systems (RecSys) 2011. This dataset consists of 4 536 891 5-star ratings provided by N=171 670 users on M=23 974 movies, as well as additional information about household membership for a subset of 602 users. The 290 households comprise 272, 14 and 4 households of size 2, 3 and 4 users, respectively. The entire dataset was used to compute the movie profiles vⱼ through matrix factorization, using d=10 (found to be optimal through cross validation). In the sequel, attention is restricted to the 544 users belonging to households of size 2. To simulate a composite account, the ratings provided by users belonging to the same household were merged. The original mapping of ratings to household members serves as the ground truth.

A second dataset used was the Netflix dataset. The second dataset contains 5-star ratings given by N=480 189 users for M=17 770 movies. The movie profiles Vⱼ were obtained through matrix factorization on the entire dataset, with d=30. Attention is restricted to the subset of 54 404 users who rated at least 500 movies. Also, 300 ‘synthetic’ households of size 2 were generated by pairing the ratings of 600 randomly selected users. Matrix factorization is likely to be unreliable for extracting account feature vectors, as they may be composite. On the other hand, it appears to perform well for movies. The OPTSPACE algorithm is used in both datasets for matrix factorization, which is not further discussed.

The algorithms of Expected Maximization (EM) and Generalized Principal Components Analysis (GPCA) are discussed herein. The EM algorithm identifies the parameters of mixtures of distributions. It naturally applies to subspace clustering—technically, this is “hard” or “Viterbi” EM. Proceeding over multiple iterations, alternately minimizing the MSE in terms of the movie-user mapping of ratings in partition I and the user profiles Θ. Initially, a mapping I⁰∈J is selected uniformly at random; at step k≧1, the profiles and the mapping are computed as follows.

$$\begin{matrix}{Θ}^{k} = {arg min}_{Θ ∈ {R}^{n \times ( d + 1 )}} MSE ( Θ , {I}^{k - 1} ) & ( 4 ) \\ {Θ}^{k} = {arg min}_{I ∈ 𝒥} MSE ( {Θ}^{k} , I ) & ( 5 )\end{matrix}$$

The minimization in EQ. (4) can be solved through linear regression. For example, obtain a mapping I: [symbol] →[n]=H by clustering the rating events (vᵢ,rⱼ)∈ [symbol] ^{d+1}, j∈ [symbol] into n clusters. Then, given I, estimate θᵢ=(uᵢ,zᵢ), i∈[n], by solving the quadratic program min_{Θ} M SE (Θ,I) where MSE is given by EQ (3). EQ. (5) amounts to identifying the profile that best predicts each rating, i.e.,

$${I}^{k} ( j ) = {arg min}_{i ∈ H} {( {r}_{j} - {z}_{i}^{k} - < {u}_{i}^{k} , {v}_{j} > )}^{2} , j ∈ . \qquad ( 6 )$$

which can be computed in O(nm) time.

The Generalized Principal Components Analysis (GPCA) algorithm is an algebraic-geometric algorithm for solving the general subspace clustering problem, as defined herein above. To give some insight on how GPCA works, consider first an idealized case where the noise εⱼ in the linear model (1) is zero. Then, the points xⱼ=(vⱼ,1,rⱼ), j∈A*ᵢ, lie exactly on a hyperplane with normal n*ᵢ=(u*ᵢ,z*ᵢ,−1). Thus, every xⱼ, j∈ [symbol] , is a root of the following homogeneous polynomial of degree n:

$${P}_{c} ( x ) = {\prod }_{i ∈ H} < {n}_{i}^{*} , x >= {\prod }_{i ∈ H} {\sum }_{k = 1}^{d + 2} {n}_{ik}^{*} {x}_{jk} \\ {\sum }_{{k}_{1} + ⋯ + {k}_{d + 2} = n , ∀ {lk}_{𝓁} \geq 0} {c}_{{k}_{1} , … , {k}_{d + 2}} {x}_{1}^{{k}_{1}} … {x}_{d + 2}^{{k}_{d + 2}} \qquad ( 7 )$$

Denoted by

$$c ∈ {ℝ}^{K ( n , d )} , where K ( n , d ) = ( \begin{matrix}n + d + 1 \\ n\end{matrix} ) ,$$

the vector of the monomial coefficients cₖ_{₁}_{, . . . , k}_{_{d+2}}. Note that P_{c} is uniquely determined by c. Moreover, provided that m=| [symbol] |≧K(n,d)=O(min(n^{d},dⁿ)), c can be computed by solving the system of linear equations P_{c}(ⱼ)=0, j∈ [symbol] .

Knowledge of c can be used to exactly recover I*, up to a permutation. This is because, by EQ (7), for any j∈A*ᵢ, the gradient ∇P_{c}(xⱼ) is proportional to the normal n*ᵢ. Hence, the partition in of points {A*ᵢ} can be recovered by grouping together points with co-linear gradients.

Unfortunately, this result does not readily generalize in the presence of noise. In this case, one approach is to estimate by solving the (non-convex) optimization problem.

$$Minimize \text{:} {\sum }_{j ∈ [ m ]} {\vert x \vert}_{j} {-}_{j} {\vert \dot{x} \vert}_{2}^{2} \\ Subject to {P}_{c} ( {\dot{x}}_{j} ) = 0 \qquad ( 8 )$$

Solving EQ (8) is accomplished through a first order approximation of P_{c} and cluster gradients using a “voting” method as known to those of skill in the art.

Evaluation by the inventors of the EM and GPCA algorithms provided statistically significant accuracy results. The user identification algorithmic methods presented above assume a priori knowledge of the number of users sharing a composite account. However, this information may not be readily available. Discussed below is a model selection algorithm for this task.

The problem of estimating the number of unknown parameters in a model is known as model selection. Denoting by Θₙ∈ [symbol] R^{n×(d+1)}, Iₙ∈J the estimators of the parameters a*, I* of the linear model EQ (1) for size n, the general method for model selection amounts to determining n that minimizes

$$- \frac{1}{m} L ( {Θ}_{n} , {I}_{n} ) + \frac{C ( {Θ}_{n} , {I}_{n} )}{m} where L ( {Θ}_{n} , I )$$

is the log-likelihood of the data, given by EQ (2), and C is a metric capturing the model complexity, usually as a function of the number of parameters n. Several different approaches for defining C exist. The inventors have found that the well known Bayesian Information Criterion (BIC) algorithm performed best over the datasets used.

The BIC for a household H of size |H|=n is given by

$${BIC}_{n} := \frac{1}{2 {σ}^{2}} MSE ( {Θ}_{n} , {I}_{n} ) + \frac{2 n ( d + 1 ) log m}{m} . \qquad ( 9 )$$

where σ² is the variance of the Gaussian noise in EQ (1). Note that different methods for obtaining the estimators Θₙ, Iₙ lead to different values for BICₙ.

BIC was tested on the two datasets as follows. For the CAMRa2011 (Netflix) dataset, a combined dataset was created comprising the 272 (300) composite accounts of n=2 as well as as the 544 (600) individuals of size n=1 that are included in these households, yielding a total of 816 (900) accounts. For each of these accounts, the MSE is first computed under the assumption that n=1; this amounted to solving a regression for a single profile θ₁=[u₁,z₁] under I(j)=1, for all j∈ [symbol] , obtaining an MSE denoted by MSE₁. Subsequently, the identification methods (EM, GPCA) were used to obtain a mapping I: [symbol] →H, and vectors θᵢ=(uᵢ,zᵢ), i∈{1,2}: each of these yielded an MSE for n=2, denoted by MSE₂.

Using these values, the following classifier was constructed. An account may be labeled as composite when

(MSE₁−MSE₂)−τ log m/m>0 (10)

By varying τ, the classifier can be made more or less conservative towards declaring accounts as composite. For τ=2σ²(d+2), this classifier coincides with BIC.

Knowledge of household composition can be used to improve recommendations. In a typical setup, a user accesses the account and the recommender system suggests a small set of movies from a catalog, recommending movies that are likely to be rated highly. However, even if the recommender system knows the household composition and the user profiles, it still does not know who might be accessing the account at a given moment. In the absence of side information, the present invention can circumvent this problem as follows. Assume the recommender has a budget of K movies to be displayed; it can then recommend the union of the K/n movies that are most likely to be rated highly by each of the n users. This exploits household composition, without requiring knowledge of who is presently accessing the account.

Having developed the algorithmic background for a technique of user identification solely on the ratings provided by users based on subspace clustering, application of the now-developed principles is discussed.

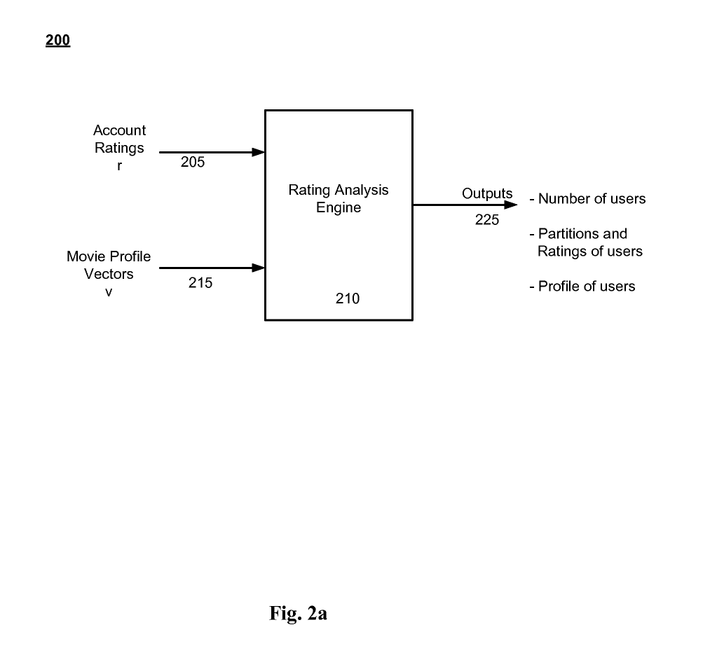

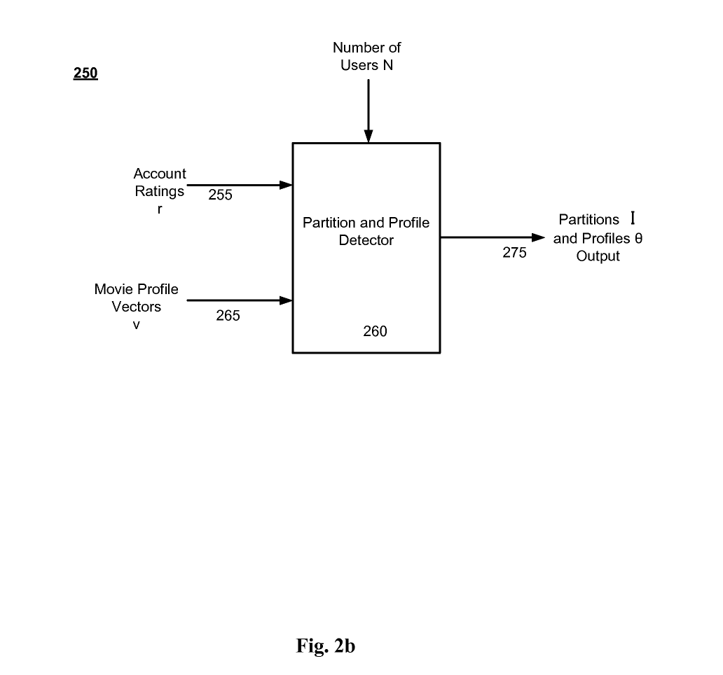

FIG. 2a depicts a functional diagram 200 of a rating analysis engine 210. The rating analysis engine accesses account ratings 205 and movie profile vectors 215, processes those inputs, and produces multiple outputs 225. The outputs include the number n of partitions corresponding to the number of users that are present in the account ratings, the number of partitions and ratings associated with those partitions present in the account ratings, and profiles associated with the identified users. The rating analysis engine can be used as a core device to provide an identification of separate users in a composite ratings set.

In one utilization of the ratings analysis engine 210, once the individual users are separated from the composite account ratings (that is, identified as separate users within the composite accounts rating set), then the individual user's ratings information can be used to perform data analysis on the separated composite ratings list. In one embodiment, the separate user ratings can be processed to determine demographic information about the individual user. Once demographic information is determined, then targeted advertisements can be given to those identified users based on their determined demographic information.

FIG. 2b depicts a function block diagram 250 of a partition and profile detector 260 used within the rating analysis engine 200 of FIG. 2a. The partition and profile detector 260 of FIG. 2b utilizes account ratings 255, movie profile vectors 265, and a given value of the number of users (n) to perform calculations and output 275 partitions I and profiles θᵢ corresponding to the account ratings 255. The partition and profile detector 260 essentially utilizes the algorithms of Equations (4) and (5), with a given n to calculate values of partitions and profiles for account ratings provided to the partition and profile detector 260 by the rating analysis engine 210.

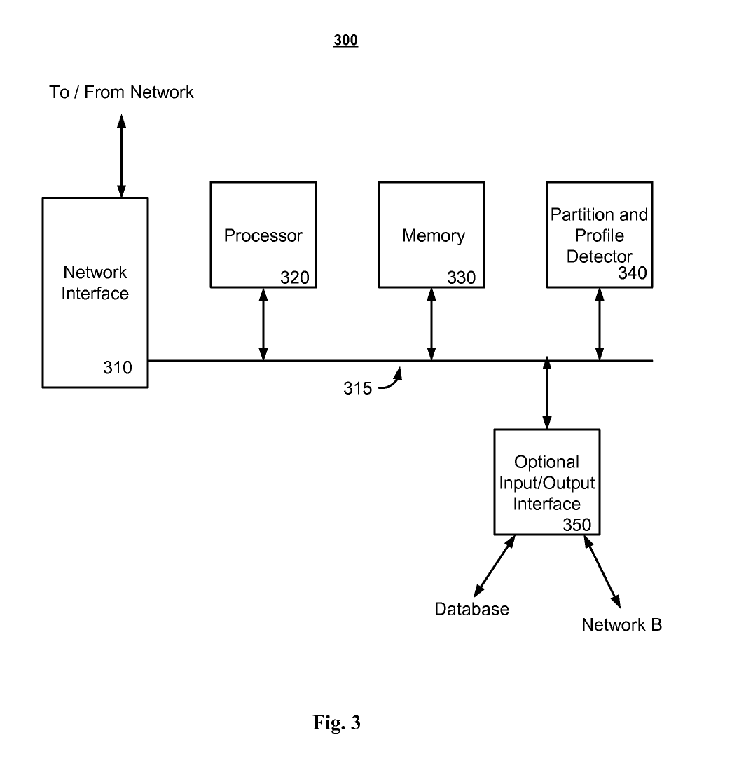

FIG. 3 is one example block diagram 300 of the ratings analysis engine of FIG. 2a. The block diagram configuration includes a bus-oriented 315 configuration interconnecting a processor 320, memory 330, and a partition and profile detector 340. The configuration also includes a network interface 310 which allows access to a private or public network, such as a corporate network or the Internet, either via wired or wireless interface. Traffic via network interface 310 includes but is not limited to account ratings, movie profile vectors, user partitions and user profiles. Optionally included is an input/output interface 350 for data access or storage such as for local or remote database access or local or remote network access.

Processor 320 provides computation functions for the rating analysis engine 300, which corresponds to functional diagram 200. The processor can be any form of CPU or controller that utilizes communications between elements of the rating analysis engine to control communication and computation processes for the engine. Those of skill in the art recognize that bus 315 provides a communication path between the various elements of engine 300 and that other point to point interconnection options instead of a bus architecture are also feasible.

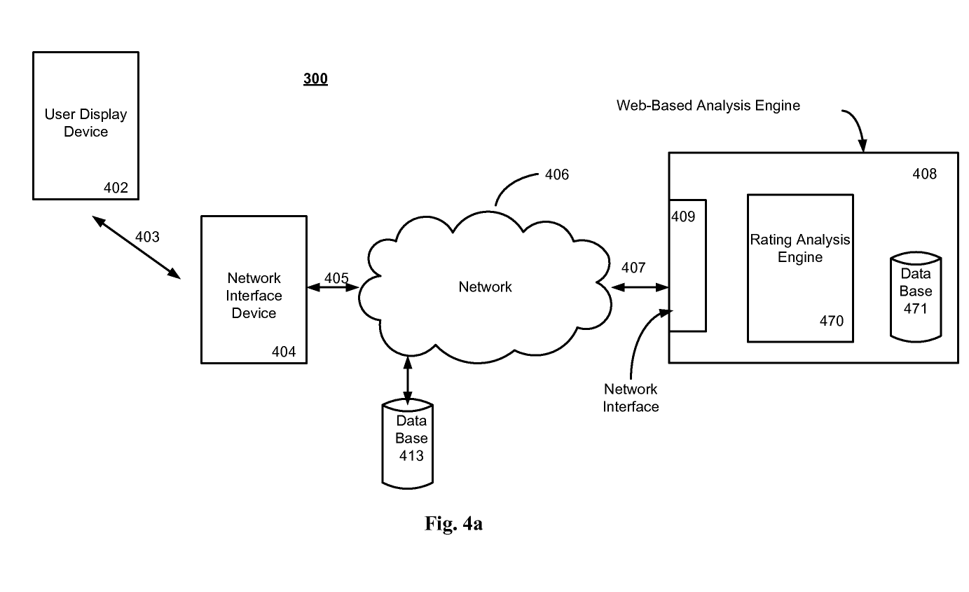

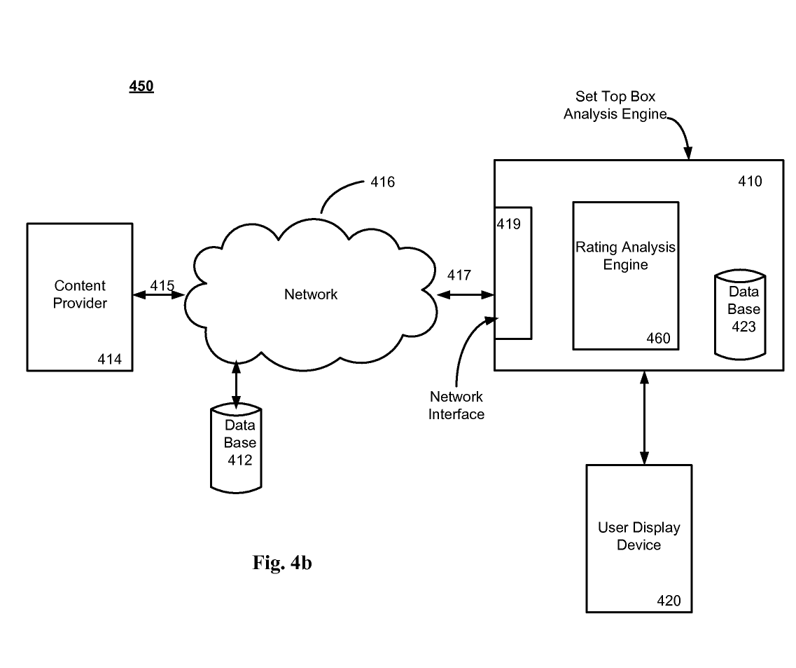

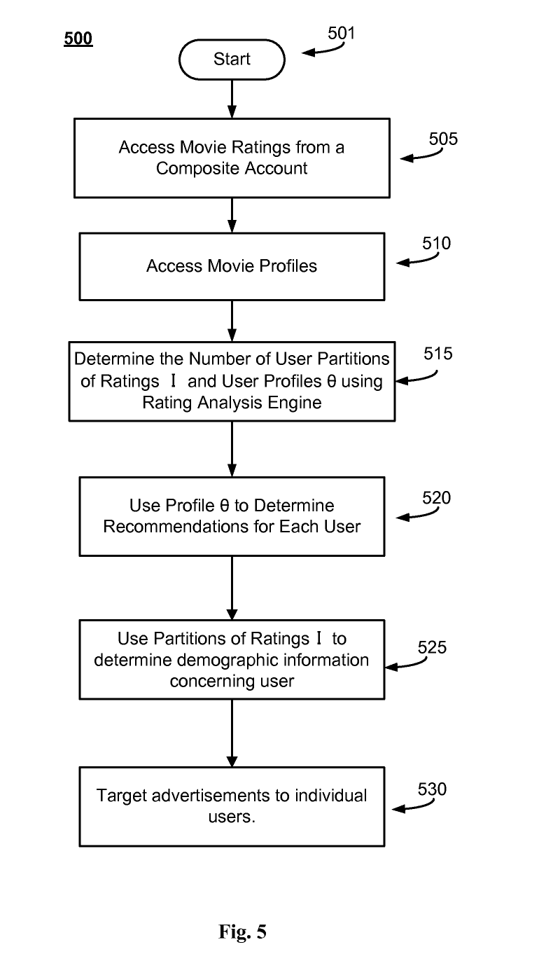

Memory 330 can provide a repository for memory related to the method that incorporates the functionality of the ratings analysis engine. Memory 330 can provide the repository for storage of information such as program memory, downloads, uploads, or scratchpad calculations. Those of skill in the art will recognize that memory 330 may be incorporated all or in part of processor 320. Processor 320 utilizes program memory instructions to execute a method, such as method 500 of FIG. 5, to process account ratings and movie profiles received as well as to and to produce output data and requests for final actions such as advertisement placements when used in an advertisement placement function such as those of FIGS. 4a and 4b. Network interface 310 has both receiver and transmitter elements for network communication as known to those of skill in the art.

Partition and profile detector 340 acts to implement the functions of the partition detector of FIG. 2b. Partition and profile detector 340 may be a hardware implementation or a combination of hardware and software/firmware. Alternately, partition and profile detector may be implemented as a co-processor responding to processor 320. In an alternative configuration, processor 320 and partition and profile detector 340 may be integrated into a single processor.

The rating and analysis engine 300 of may be integrated as a functional element in a device, such as a web-based analysis engine or a set top box, as discussed herein below with respect to FIGS. 4a and 4b. FIG. 4a depicts an example configuration 400 of a web-based analysis engine according to elements of the invention. In FIG. 4a, a ratings analysis engine 470 forms a core element of a web-based analysis engine 408. Engine 408 could be implemented in service provider equipment such as equipment for Netflix™ or Hulu™ Engine 408 can thus act as a recommender system which can provide recommendations of movies to individual users. As such, the engine 408 can receive account rating information generated by multiple users of user device 402 as well as provide recommendations to users.

User device 402 may be a digital television, a smart phone, PDA, tablet or conventional laptop computer, or a fixed location personal computer (PC). Users of device 402 view digital content, such as movies and other video, and provide ratings of the viewed content via link 403 to a network interface 404. Network interface 404 may be part of user device 402. The composite rating information is transferred via link 405, through network 406 and link 407 to the network interface 407 of the engine 408. Network Interfaces 404 and 409 each contain receivers and transmitters (transceivers) for two-way communication to and from network 406.

The composite rating information received by engine 408 may include ratings from multiple users of device 402. Engine 408 uses the rating analysis engine 470 to separate out the individual users, determine which user is associated with which rating, and can profile the user sufficiently to provide movie and video recommendations back to a user. In one application of the invention, engine 408 may also use the determined ratings to infer demographic information of each separate user and utilize that newly determined demographic information to target advertisements to a user. The inference of demographic information using ratings is discussed in U.S. Provisional Application No. 61/662,609 entitled “Method and Apparatus For Inferring User Demographics Based on Ratings”, which has inventors in common with the invention discussed herein.

Information regarding advertisements can be obtained via web-based database 413 or via local database 471 which may be accessed by engine 408 via a rating and analysis engine input/output interface, such as interface 350. The placement of advertisements may involve the engine 408 utilizing the processing capability of the rating analysis engine 470 to also perform processing on ratings determined via the use of the rating analysis engine 470 and to select advertisements from a database of advertisements such as database 413 or database 471. Once selected the advertisement can be sent to the user via transceivers of the network interfaces 409 and 404 to be received by user device 403.

FIG. 4b depicts an example configuration 450 of a set top box (STB) based analysis engine 410 according to elements of the invention. In FIG. 4b, a ratings analysis engine 460 forms a core element of a STB-based analysis engine 410. As part of a STB, the engine 460 can receive account rating information generated by multiple users of user device 420. User device 420 may be a digital television, a smart phone, PDA, tablet or conventional laptop computer, or a fixed location personal computer (PC). Users of device 420 view digital content, such as movies and other video, and provide ratings of the viewed content to the

STB. The composite rating information is provided to the rating analysis engine 460. In the configuration of FIG. 4b, network interface 419 contains receivers and transmitters (transceivers) for two-way communication to and from network 416 to provide digital content via content provider 414 via network 416 links 415 and 417.

The composite rating information received by the rating analysis engine 460 may include ratings from multiple users of device 420. STB based engine 410 uses the rating analysis engine 460 to separate out the individual users, determine which user is associated with which rating, and can profile the user sufficiently to provide movie and video recommendations back to a user. Such recommendations may be provided via communications from content provider 414 after STB analysis engine 410 provides content provider 414 rating and user profile information determined from the ratings and analysis engine 460.

As discussed above with respect to FIG. 4a, one outcome of determining demographic information of a specific user is that advertisements targeting user needs can be generated and sent to the individual user. With respect to FIG. 4b, such advertisements can be obtained via web-based database 412 or via local database 423 which may be accessed by engine 460 via a rating and analysis engine input/output interface, such as interface 350. The placement of advertisements may involve STB based analysis engine 410 utilizing the processing capability of the rating analysis engine 460 to also perform processing on ratings determined via the use engine 460 and to select advertisements from a database of advertisements such as database 412 or database 423. Once selected, the advertisement can be sent to the user device 420.

FIG. 5 depicts an example method 500 performed by a web-based analysis engine 408 or by a set-top-box analysis engine 410. The example method functions to determine the number of users in a composite account of ratings, such as movie ratings, and provide ratings for each of the users in the composite account of ratings, as well as profile the users. In addition, in one embodiment, the method can be used to generate recommendations for each of the separate users of the account as well as to determine demographic information and provide individual users with targeted advertisements.

Process 500 starts at step 501 and moves to access movie ratings in a composite account at step 505. As discussed above, such movie ratings can contain multiple users and the number of users may not be known a priori. Accessing movie ratings in a composite account includes loading the composite set of movie ratings into a rating analysis engine, such as that of FIG. 2a. At step 510, movie profiles are accessed. Accessing movie profiles includes loading the movie profiles into a rating analysis engine, such as that of FIG. 2a. Movie profiles contain characterizing information concerning the movie, such as genre, actors, dates, etc. The movie profiles accessed in step 510 include at least those profiles that are associated with movies that are rated in the composite set of ratings. Steps 505 and 510 may be performed in either order or concurrently (in parallel).

At step 515, the partition and profile detector is used to determine a number of partitions of the composite ratings that were input at step 505. User profiles are also generated at step 515 via the partition and profile detector, such as the one described in conjunction with FIG. 2b. In one embodiment, the Expectation Maximization (EM) algorithm is used within the partition and profiling detector. As explained above, the EM algorithm identifies the parameters of mixtures of distributions and is indicative of subspace clustering. Also, as an aspect of the invention, the determined number of partitions is indicative of the number of individual users in the composite ratings account. The determination of individual users is useful in itself and the process can end after step 515. However, further action can be taken as a result of the usefulness of the results of step 515.

Step 520 further uses the results of step 515 by using profile information from the individual users in the composite ratings to determine recommendations for each user. In the instance of a web-based analysis engine, such as shown in FIG. 4a, the recommendations may be suggested movies. These are provided as a result of the prediction of movie ratings by an identified user using Equation 6. If a predicted rating for a movie is high using the profile information of a specific user, then that movie can be used as a recommendation if the user has not yet viewed the movie. In one embodiment, the predictor of Equation 6 can predict the top ten movies for an individual user and suggest those movies that the user has not yet viewed. The predicted ratings can be calculated with the help of a database of movie profile vectors provided from a content provider. The predicted ratings can be provided to a recommender system, such as a web-based content provider that provides movie recommendations. In the instance of the web-based analysis engine of FIG. 4a, the content provider can be connected to or integrated with the analysis engine 408. In the instance of a STB, as in FIG. 4b, the content provider may be an entity, such as content provider 414, available to the STB via a network connection.

Returning to the flow diagram of FIG. 5, the process 500 can stop at the end of step 520. However, if combined with other innovations of the inventors, demographic information from the separate users can be determined from the ratings that are now associated with each of the separate users in the composite account of ratings. For example, demographic information of an individual user may be obtained through her individual rating information gleaned from the account of composite ratings. Examples of demographic information include a determination of age, gender, or political affiliation of the user.

Step 530 utilizes the determined demographic information to target advertisements to an individual user determined from the composite ratings. Selection of such a targeted advertisement can be determined from a database of advertisements which can be available on a network connection, such as that of networked database items 413 and 412 of FIGS. 4a and 4b respectively.

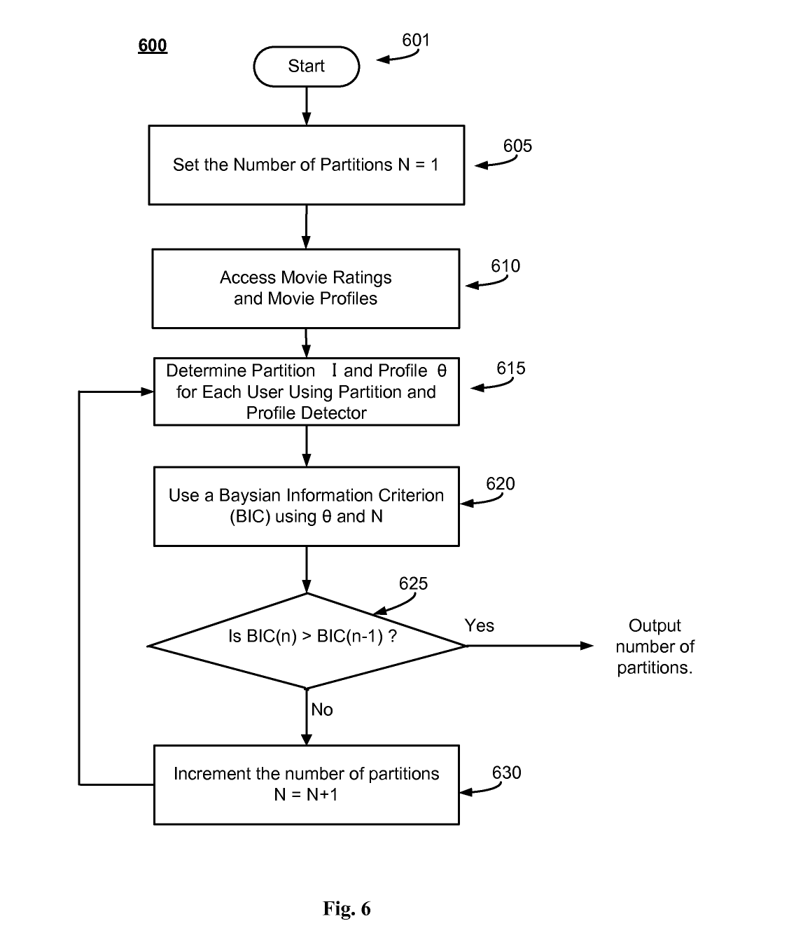

FIG. 6 is an example flow diagram 600 performed by the partition and profile detector of FIGS. 2b and 3. The example method 600 of FIG. 600 is useful to determine the number of partitions in a composite rating set provided to a rating analysis engine such as that of FIG. 2a. In one aspect of the invention, the number of partitions with which the composite ratings can be split up indicates the number of users. Stated another way, using subspace clustering, such as that of equations 4 and 5 of the EM algorithm, the number of hyperplanes that are determined indicate the number of individual users that provided ratings in the composite ratings input to a ratings analysis engine.

The process 600 starts at step 601 and moves to step 605 to set the number of partitions (users) to 1. Access to the composite movie ratings and movie profiles is provided in step 610. As previous described, the provided movie ratings are a composite set of movie ratings which may represent a single account for a service such as Netflix™ or Hulu™ where multiple individuals have access to the one account. The movie profiles include feature vectors as described herein above.

Partition and profile information for each user is determined at step 615. Partition and profile information is determined using the partition and profile detector 260 of FIG. 2b, where the number of users n is provided to the unit 260. Step 615 is effected via the application of equations 4 and 5. At step 620, the results of the partitions and profiles determined in step 615 are used to calculate a value of the Bayesian Information Criterion (BIC) as described by the algorithm of equation 9. Although step 615 was performed by the partition and profile detector 260, the other steps of method 600 are performed by the rating analysis engine 210 of FIG. 2a.

At step 625 the value of BIC for a value of n and a value of BID for a value of n−1 are compared. Generally, the correct value of partitions, and hence users is the minimum of the determination sought in step 625. If the value of BIC using n starts to rise and is greater than the value of BIC previously calculated using n−1, then the determination of step 625 is affirmative and the process 600 terminates by providing the correct value of partitions or users. At the affirmative conclusion of step 625, the correct value of partitions, and hence users, is n−1.

If the determination at step 625 is negative, that is, if BIC(n) is less than or equal to BIC(n−1), then the value of BIC is not yet increasing and a minimum value of BIC may not have been reached. As a result, if the determination at step 625 is negative, the number n is increased by 1 at step 630. The process then continues iteratively to step 615 where the number of partitions and profiles for the partitions are determined As previously described, once the number of partitions of the composite ratings is determined using method 600, the number of users is equivalent to the number of partitions in the composite ratings because each partition corresponds to a hyperplane mapping of the composite rating set.

Although specific architectures are shown for the implementation of an analysis engine such as that of example embodiments of FIGS. 4a and 4b, one of skill in the art will recognize that implementation options exist such as distributed functionality of components, consolidation of components, and location in a server as a service to recommender systems.

Such options are equivalent to the functionality and structure of the depicted and described arrangements.

1. A method to detect a number of individual users corresponding to movie ratings in a composite set of movie ratings, the method comprising:
accessing the composite set of movie ratings by loading the composite set into a rating analysis engine;
accessing a set of movie profiles by loading the set of movie profiles into the rating analysis engine;
determining a number of partitions of movie ratings present in the composite set by processing the composite set using the movie profiles, wherein the number of partitions is determined iteratively using subspace clustering of ratings from the composite set;
outputting the number of determined partitions, the determined number of partitions corresponding to the number of individual users.

2. The method of claim 1, wherein accessing a set of movie profiles comprises accessing a set of movie profiles corresponding to movies present in the composite set.

3. The method of claim 1, wherein determining the number of partitions further comprises determining user profiles and a movie-user mapping of ratings from the composite set.

4. The method of claim 3, wherein the determined number of partitions are computed by alternately minimizing a mean square error of the movie-user mapping and the user profiles.

5. The method of claim 1, wherein determining a number of partitions of movie ratings present in the composite set comprises determining a number of hyperplanes associated with movie ratings in the composite set of movies.

6. The method of claim 1, further comprising providing a user profile for each individual user identified in the composite set of movie ratings.

7. The method of claim 6, further comprising providing the user profile for each individual user to a recommender system to determine recommendations for each user.

8. The method of claim 7, further comprising determining demographic information from ratings associated with each individual user.

9. The method of claim 8, further comprising targeting advertisements to a selected individual user based on the determined demographic information.

10. An apparatus to detect a number of individual users corresponding to movie ratings in a composite set of movie ratings, the apparatus comprising:
a network interface to access the composite set of movie ratings and movie profiles;
a processor having access to memory to execute instructions which utilize a subspace clustering algorithm to compute a number of partitions of movie ratings present in the composite set;
outputting the number of determined partitions, the determined number of partitions corresponding to the number of individual users.

11. The apparatus of claim 10, wherein the network interface enables access to the movie profiles which correspond to movies present in the composite set.

12. The apparatus of claim 10, wherein the processor further computes user profiles and a movie-user mapping of ratings from the composite set.

13. The apparatus of claim 10, wherein the determined partitions are computed by alternately minimizing a mean square error of the movie-user mapping and the user profiles.

14. The apparatus of claim 10, wherein the processor computes the number of partitions using hyperplanes associated with the movie ratings in the composite set of movies;

15. The apparatus of claim 10, wherein the processor computes the number of partitions iteratively using subspace clustering of the movie ratings from the composite set.
